(19) United States
(12) Patent Application Publication
(10) Pub. No.: US 2020/0134454 A1
(43) Pub. Date: Apr. 30, 2020

(54) APPARATUS AND METHOD FOR TRAINING DEEP LEARNING MODEL

(71) Applicant: SAMSUNG SDS CO., LTD., Seoul (KR)

(72) Inventors: Jong-Won Choi, Seoul (KR); Ji-Hoon Kim, Seoul (KR); Young-Joon Choi, Seoul (KR)

(21) Appl. No.: 16/665,751

(22) Filed: Oct. 28, 2019

(30) Foreign Application Priority Data
Oct. 30, 2018 (KR) 10-2018-0130779

(51) Int. Cl. G06N 3/08; G06N 3/04; G06F 17/16

(52) U.S. Cl. CPC G06N 3/08; G06F 17/16; G06N 3/0454

(57) ABSTRACT

An apparatus and a method for training a deep learning model are disclosed. According to the disclosed embodiments, performance of deep learning can be enhanced by performing bidirectional training of learning information on the target dataset on the basis of the source dataset and learning information on the source dataset on the basis of the target dataset.

### CROSS-REFERENCE TO RELATED APPLICATION(S)

This application claims the benefit under 35 USC § 119(a) of Korean Patent Application No. 10-2018-0130779, filed on Oct. 30, 2018, in the Korean Intellectual Property Office, the entire disclosure of which is incorporated herein by reference for all purposes.

### BACKGROUND

### 1. Field

The disclosed embodiments relate to a technique of training a deep learning model.

### 2. Description of Related Art

Deep learning includes supervised learning and unsupervised learning. Training data assigned with a label is essential for the supervised learning. At this point, since a user should assign a label to each training data for the supervised learning, a lot of time and labor are required.

The unsupervised learning learns information on a dataset not assigned with a label on the basis of a dataset assigned with a label. At this point, the unsupervised learning may train a model using a dataset not assigned with a label.

However, currently, a deep learning model based on unsupervised learning has a problem of low image classification performance. In addition, since a conventional technique is capable of only one-directional learning of learning information on a dataset not assigned with a label on the basis of a dataset assigned with a label, there is a problem in that performance of learning varies greatly according to the configuration, type or the like of a dataset.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are for providing an apparatus and a method for training a deep learning model.

In one general aspect, there is provided a method for training deep learning model, which performed by a computing device including one or more processors and a memory for storing one or more programs executed by the one or more processors, the method comprising: training a deep learning-based forward network using a source dataset assigned with a first label and a target dataset not assigned with a label as training data; determining a final noisy label matrix for a deep learning-based inverse network using a plurality of previously generated noisy label matrixes and the inverse network; training the inverse network on the basis of the final noisy label matrix; training a deep learning-based integrated network, which is combined the trained forward network and the trained inverse network, on the basis of the first label and a second label of the source dataset; and determining the forward network included in the trained integrated network as a deep learning model.

The training of the forward network may train the forward network to extract a label for the target dataset not assigned with a label on the basis of the source dataset assigned with the first label, wherein the forward network may be trained on the basis of a loss function set in the forward network.

The method for training deep learning may further include extracting a third label for the target dataset not assigned with a label from the source dataset assigned with the first label and the target dataset not assigned with a label using the trained forward network.

The determining of the final noisy label matrix may include: training the inverse network for the first time to extract a label for the source dataset not assigned with a label on the basis of the target dataset assigned with the third label, wherein the inverse network may be trained on the basis of a loss function set in the inverse network; retraining the first-time trained inverse network on the basis of each of the plurality of noisy label matrixes; extracting a fourth label for the source dataset not assigned with a label from the target dataset assigned with the third label and the source dataset not assigned with a label using the trained inverse network on the basis of the each of the plurality of noisy label matrixes; and determining one of the plurality the noisy label matrixes as the final noisy label matrix on the basis of the first label and the fourth label.

The training of the inverse network may include the step of retraining the first-time trained inverse network on the basis of the final noisy label matrix and a loss function based on cross entropy.

The training of the inverse network may extract the second label for the source dataset not assigned with a label from the target dataset assigned with the third label and the source dataset not assigned with a label using the trained inverse network, and the training of the integrated network may train the integrated network on the basis of the loss function set in the integrated network so that the value of the second label may approach the value of the first label.

The loss function set in the integrated network may be generated on the basis of loss functions respectively set in the forward network and the inverse network and a loss function based on an auto-encoder.

The training of the integrated network may calculate accuracy of each of a plurality of training samples included in the source dataset and the target dataset on the basis of the final noisy label matrix, and train the integrated network using a training sample of which the accuracy is higher than a preset value among the plurality of training samples.

In another general aspect, there is provided an apparatus for training deep learning model comprises one or more processors, a memory, and one or more programs, wherein the one or more programs are stored in the memory and configured to be executed by the one or more processors and include instruction for executing the steps of: training a deep learning-based forward network using a source dataset assigned with a first label and a target dataset not assigned with a label as training data; determining a final noisy label matrix for a deep learning-based inverse network using a plurality of previously generated noisy label matrixes and the inverse network; training the inverse network on the basis of the final noisy label matrix; training a deep learning-based integrated network, which is combined the trained forward network and the trained inverse network, on the basis of the first label and a second label of the source dataset; and determining the forward network included in the trained integrated network as a deep learning model.

The step of training the forward network may train the forward network to extract a label for the target dataset not assigned with a label on the basis of the source dataset assigned with the first label, wherein the forward network may be trained on the basis of a loss function set in the forward network.

The one or more programs may further include instructions for executing the step of extracting a third label for the target dataset not assigned with a label from the source dataset assigned with the first label and the target dataset not assigned with a label using the trained forward network.

The step of determining a final noisy label matrix may include the steps of: training the inverse network for the first time to extract a label for the source dataset not assigned with a label on the basis of the target dataset assigned with the third label, wherein the inverse network may be trained on the basis of a loss function set in the inverse network; retraining the first-time trained inverse network on the basis of each of the plurality of noisy label matrixes; extracting a fourth label for the source dataset not assigned with a label from the target dataset assigned with the third label and the source dataset not assigned with a label using the trained inverse network on the basis of the each of the plurality of noisy label matrixes; and determining one of the plurality of noisy label matrixes as the final noisy label matrix on the basis of the first label and the fourth label.

The step of training the inverse network may include the step of retraining the first-time trained inverse network on the basis of the final noisy label matrix and a loss function based on cross entropy.

The step of training the inverse network may extract the second label for the source dataset not assigned with a label from the target dataset assigned with the third label and the source dataset not assigned with a label using the trained inverse network, and the step of training an integrated network may train the integrated network on the basis of the loss function set in the integrated network so that the value of the second label may approach the value of the first label.

The loss function set in the integrated network may be generated on the basis of loss functions respectively set in the forward network and the inverse network and a loss function based on an auto-encoder.

The step of training the integrated network may calculate accuracy of each of a plurality of training samples included in the source dataset and the target dataset on the basis of the final noisy label matrix, and train the integrated network using a training sample of which the accuracy is higher than a preset value among the plurality of training samples.

Other features and aspects will be apparent from the following detailed description, the drawings, and the claims.

### BRIEF DESCRIPTION OF THE DRAWINGS

FIG. 1 is a block diagram for describing a computing environment including a computing device suitable to be used in exemplary embodiments.

FIG. 2 is a flowchart illustrating a deep learning model training method according to an embodiment.

FIG. 3 is a view showing an example of training a forward network according to an embodiment.

FIG. 4 is a flowchart illustrating a method of determining a final noise label according to an embodiment.

FIG. 5 is a view showing an example of training a forward network according to an embodiment.

FIG. 6 is a view showing an example of training an integrated network according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereafter, specific embodiments of the present invention will be described with reference to the accompanying drawings. The detailed description is provided below to help comprehensive understanding of the methods, apparatuses and/or systems described in this specification. However, these are only an example, and the present invention is not limited thereto.

In describing the embodiments of the present invention, when it is determined that specific description of known techniques related to the present invention unnecessarily blurs the gist of the present invention, the detailed description will be omitted. In addition, the terms described below are terms defined considering the functions of the present invention, and these may vary according to user, operator's intention, custom or the like. Therefore, definitions thereof should be determined on the basis of the full text of the specification. The terms used in the detailed description are only for describing the embodiments of the present invention and should not be restrictive. Unless clearly used otherwise, expressions of singular forms include meanings of plural forms. In the description, expressions such as “include”, “provide” and the like are for indicating certain features, numerals, steps, operations, components, some of these, or a combination thereof, and they should not be interpreted to preclude the presence or possibility of one or more other features, numerals, steps, operations, components, some of these, or a combination thereof, in addition to those described above.

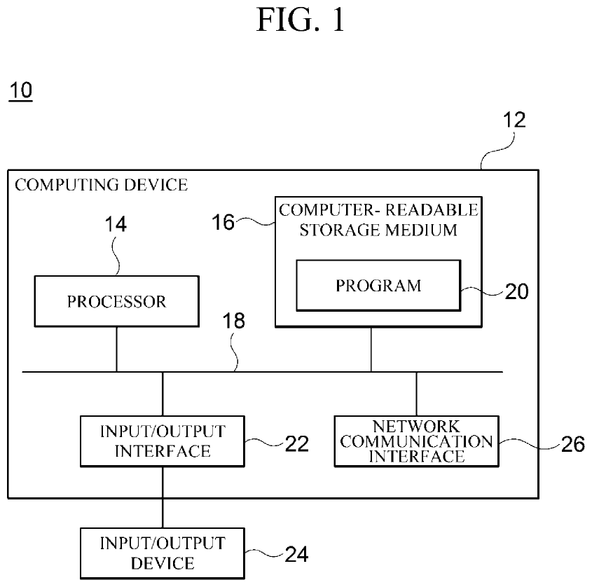

FIG. 1 is a block diagram showing an example of a computing environment 10 including a computing device appropriate to be used in exemplary embodiments. In the embodiment shown in the figure, each of the components may have a different function and ability in addition to those described below, and additional components other than those described below may be included.

The computing environment 10 shown in the figure includes a computing device 12. In an embodiment, the computing device 12 may be the deep learning model training apparatus according to the embodiments. The computing device 12 includes at least a processor 14, a computer-readable storage medium 16, and a communication bus 18. The processor 14 may direct the computing device 12 to operate according to the exemplary embodiments described above. For example, the processor 14 may execute one or more programs stored in the computer-readable storage medium 16. The one or more programs may include one or more computer executable commands, and the computer executable commands may be configured to direct the computing device 12 to perform operations according to the exemplary embodiment when the commands are executed by the processor 14.

The computer-readable storage medium 16 is configured to store computer-executable commands and program codes, program data and/or information of other appropriate forms. The programs 20 stored in the computer-readable storage medium 16 include a set of commands that can be executed by the processor 14. In an embodiment, the computer-readable storage medium 16 may be memory (volatile memory such as random access memory, non-volatile memory, or an appropriate combination of these), one or more magnetic disk storage devices, optical disk storage devices, flash memory devices, other forms of storage media that can be accessed by the computing device 12 and is capable of storing desired information, or an appropriate combination of these.

The communication bus 18 interconnects various different components of the computing device 12, including the processor 14 and the computer-readable storage medium 16.

The computing device 12 may also include one or more input and output interfaces 22 and one or more network communication interfaces 26, which provide an interface for one or more input and output devices 24. The input and output interfaces 22 and the network communication interfaces 26 are connected to the communication bus 18. The input and output devices 24 may be connected to other components of the computing device 12 through the input and output interfaces 22. Exemplary input and output devices 24 may include input devices such as a pointing device (a mouse, a track pad, etc.), a keyboard, a touch input device (a touch pad, a touch screen, etc.), a voice or sound input device, various kinds of sensor devices and/or photographing devices, and/or output devices such as a display device, a printer, a speaker and/or a network card. The exemplary input and output devices 24 may be included inside the computing device 12 as a component configuring the computing device 12 or may be connected to the computing device 12 as a separate apparatus distinguished from the computing device 12.

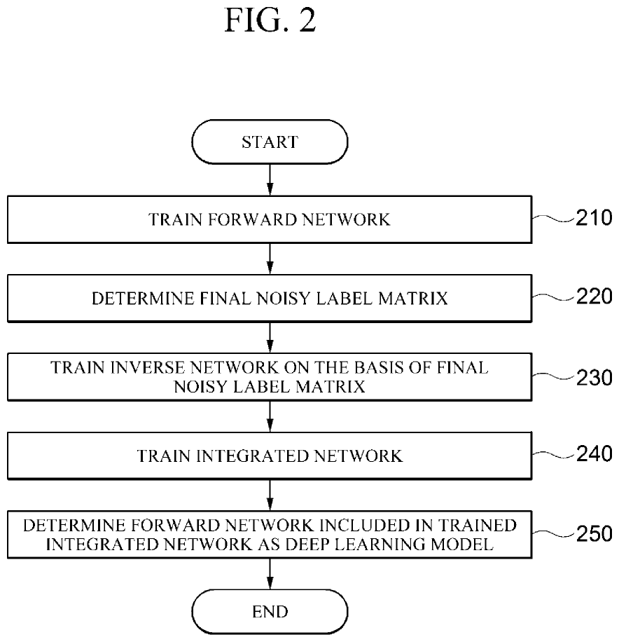

FIG. 2 is a flowchart illustrating a deep learning model training method according to an embodiment.

The method shown in FIG. 2 may be executed by the computing device 12 provided with, for example, one or more processors and a memory for storing one or more programs executed by the one or more processors. Although the method is described as being divided in a plurality of steps in the flowchart shown in the figure, at least some of the steps may be performed in a different order or in combination and together with the other steps, omitted, divided into detailed steps, or performed in accompany with one or more steps not shown in the figure.

Referring to FIG. 2, the computing device 12 trains a deep learning-based forward network using a source dataset assigned with a first label and a target dataset not assigned with a label as training data (step 210).

At this point, the forward network, and an inverse network and an integrated network described below may be a neural network including a plurality of layers.

The neural network may use artificial neurons simplifying the functions of biological neurons, and the artificial neurons may be interconnected through connection lines having a connection weight. The connection weight, which is a parameter of the neural network, is a specific value that the connection line has and may be expressed as connection strength. The neural network may perform a recognition action or a learning process of a human being through the artificial neurons. The artificial neuron may also be referred to as a node.

The neural network may include a plurality of layers. For example, the neural network may include an input layer, a hidden layer and an output layer. The input layer may receive an input for performing learning and transfer the input to the hidden layer, and the output layer may generate an output of the neural network on the basis of the signals received from the nodes of the hidden layer. The hidden layer is positioned between the input layer and the output layer and may convert the learning data transferred through the input layer into a value easy to estimate. The nodes included in the input layer and the hidden layer are connected to each other through connection lines having a connection weight, and the nodes included in the hidden layer and the output layer may also be connected to each other through connection lines having a connection weight. The input layer, the hidden layer and the output layer may include a plurality of nodes.

The neural network may include a plurality of hidden layers. The neural network including a plurality of hidden layers is referred to as a deep neural network, and training the deep neural network is referred to as deep learning. The nodes included in the hidden layer are referred to as hidden nodes. Hereinafter, training a neural network may be understood as training parameters of the neural network. In addition, a trained neural network may be understood as a neural network to which the trained parameters are applied.

At this point, the neural network may be trained using a preset loss function as an index. The loss function may be an index of the neural network for determining an optimum weight parameter through the training. The neural network may be trained for the purpose of making a result value of the preset loss function to be the smallest.

The neural network may be trained through supervised learning or unsupervised learning. The supervised learning is a method of inputting a training data, together with an output data corresponding thereto, into the neural network and updating connection weights of the connection lines so that output data corresponding to the training data may be outputted. The unsupervised learning is a method of inputting only a training data, without an output data corresponding to the training data, into the neural network and updating connection weights of the connection lines to find out the features or structure of the training data.

Meanwhile, the forward network may be trained through, for example, the unsupervised learning method.

A first label may be a label assigned in advance by the user.

Then, the computing device 12 determines a final noisy label matrix for the inverse network using a plurality of previously generated noisy label matrixes and a deep learning-based inverse network (step 220).

At this point, the noisy label matrix may mean a matrix showing the relation between actual labels and estimated labels of individual target data included in a target dataset in terms of probability. The noisy label matrix may be expressed through mathematical expression 1 shown below.

$${T}_{ij} = [ \begin{matrix}{T}_{11} & {T}_{12} & … & {T}_{1 L} \\ {T}_{21} & {T}_{22} & … & {T}_{2 L} \\ … & … & … & … \\ {T}_{L 1} & {T}_{L 2} & … & {T}_{LL}\end{matrix} ] \qquad [ Mathematical expression 1 ]$$

In mathematical expression 1, Tᵢⱼ denotes a noisy label matrix.

At this point, Tᵢⱼ may denote the probability of determining a data having label i as having label j. In addition, when i and j have the same value, Tᵢⱼ may mean a probability of an estimated label for being the same as the actual label for the target dataset. The sum of Tᵢⱼ of each column may become 1.

Next, the computing device 12 trains the inverse network on the basis of the final noisy label matrix (step 230).

Next, the computing device 12 trains a deep learning-based integrated network, which is combined the trained forward network and the trained inverse network, on the basis of the first label and a second label of the source dataset (step 240).

Meanwhile, the computing device 12 may repeatedly perform training of the forward network, the inverse network and the integrated network on the basis of a predetermined number of times through the training method described above so that the loss function set in each of the forward network, the inverse network and the integrated network becomes minimum.

Next, the computing device 12 determines the forward network included in the trained integrated network as a deep learning model (step 250).

For example, the computing device 12 may remove the inverse network from the trained integrated network and extract the forward network. At this point, the computing device 12 may use the extracted forward network as a deep learning model for solving a specific problem.

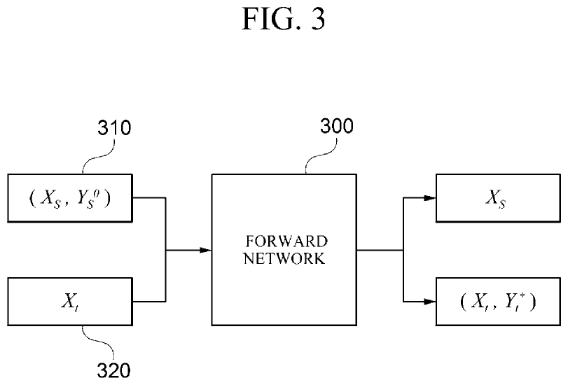

FIG. 3 is a view showing an example of training a forward network 300 according to an embodiment.

Referring to FIG. 3, the computing device 12 trains the forward network 300 to extract a label for the target dataset 320 not assigned with a label on the basis of the source dataset 310 assigned with the first label 311, and the computing device 12 may train the forward network 300 on the basis of the loss function set in the forward network 300.

For example, the computing device 12 may train the forward network 300 to extract a label for the individual target data Xₜ included in the target dataset 320 on the basis of the individual source data Xₛ and the first label Yₛ^{o} included in the source dataset 310.

In addition, the computing device 12 may extract a third label Yₜ* for the target dataset 320 not assigned with a label from the source dataset 310 assigned with the first label Yₛ^{o} and the target dataset 320 not assigned with a label using the trained forward network 300.

At this point, the third label Yₜ* may be a value estimating a label for the target dataset 320 through the trained forward network 300.

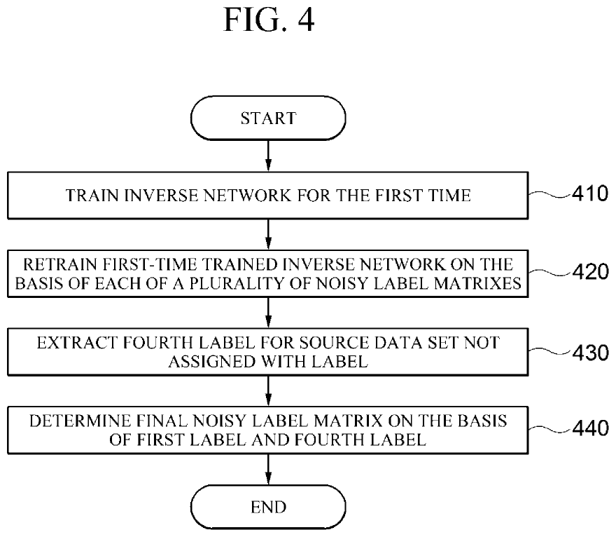

FIG. 4 is a flowchart illustrating a method of determining a final noise label according to an embodiment.

The method shown in FIG. 4 may be executed by the computing device 12 provided with, for example, one or more processors and a memory for storing one or more programs executed by the one or more processors. Although the method is described as being divided in a plurality of steps in the flowchart shown in the figure, at least some of the steps may be performed in a different order or in combination and together with the other steps, omitted, divided into detailed steps, or performed in accompany with one or more steps not shown in the figure.

Referring to FIG. 4, the computing device 12 trains the inverse network for the first time to extract a label for the source dataset not assigned with a label on the basis of the target dataset assigned with the third label, and the computing device 12 may train the inverse network on the basis of the loss function set in the inverse network.

Then, the computing device 12 may retrain the first-time trained inverse network on the basis of a plurality of noisy label matrixes (step 420).

At this point, the computing device 12 may retrain the first-time trained inverse network on the basis of, for example, a loss function based on cross entropy. At this point, the loss function based on cross entropy may be expressed through mathematical expression 2 shown below.

$${L}_{CE} = - {\sum }_{i = 1}^{N} {T}^{- 1} {y}_{i}^{* T} log ) p ( {y}_{i} \vert {x}_{i} ) ) \qquad [ Mathematical expression 2 ]$$

In mathematical expression 2, L_{CE} denotes the loss function based on cross entropy, Xᵢ denotes a training sample included in the individual target data, yᵢ denotes the probability of a label extracted when xᵢ is inputted into the forward network, and p(yᵢ|xᵢ) denotes the probability of a label extracted when xᵢ is inputted into the inverse network.

Next, the computing device 12 may extract a fourth label for the source dataset not assigned with a label from the target dataset assigned with the third label and the source dataset not assigned with a label using the trained inverse network on the basis of each of the plurality of noisy label matrixes (step 430).

At this point, the fourth label may be a value estimating a label for the source dataset through the initially trained inverse network.

Next, the computing device 12 may determine one of a plurality of noisy label matrixes as the final noisy label matrix on the basis of the first label and the fourth label (step 440).

For example, the computing device 12 may compare a value of the first label and a value of the fourth label for the source dataset. At this point, the computing device 12 may assign a score to the noisy label matrix used for training the corresponding inverse network on the basis of the difference between the value of the first label and the value of the fourth label. The smaller the difference between the value of the first label and the value of the fourth label, the computing device 12 may assign a higher score to the noisy label matrix. After the training based on a plurality of noisy label matrixes is finished, the computing device 12 may determine a noisy label matrix assigned with the highest score as the final noisy label matrix.

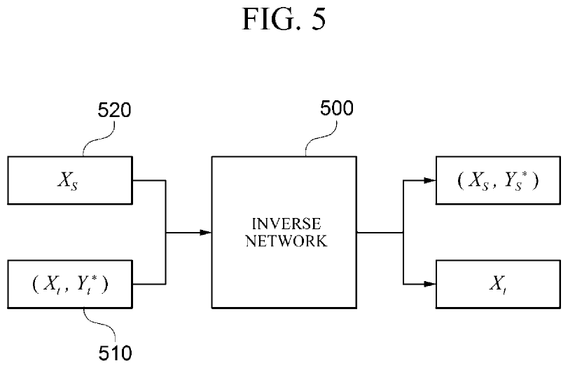

FIG. 5 is a view showing an example of training a forward network 500 according to an embodiment.

Referring to FIG. 5, the computing device 12 may retrain the first-time trained inverse network model 500 on the basis of a final noisy label matrix and a loss function based on cross entropy.

Specifically, the computing device 12 retrains the first-time trained inverse network model 500 on the basis of individual target data Xₜ and individual source data Xₛ assigned with a third label Yₜ*, and the computing device 12 may retrain the first-time trained inverse network model 500 on the basis of the final noisy label matrix and a loss function based on cross entropy.

Next, the computing device 12 may extract a second label Yₛ* for the source dataset 520 not assigned with a label from the target dataset 510 assigned with the third label Yₜ* and the source dataset 520 not assigned with a label using the trained inverse network 500.

At this point, the second label Yₛ* may be a value estimating a label for the source dataset through the trained inverse network 500.

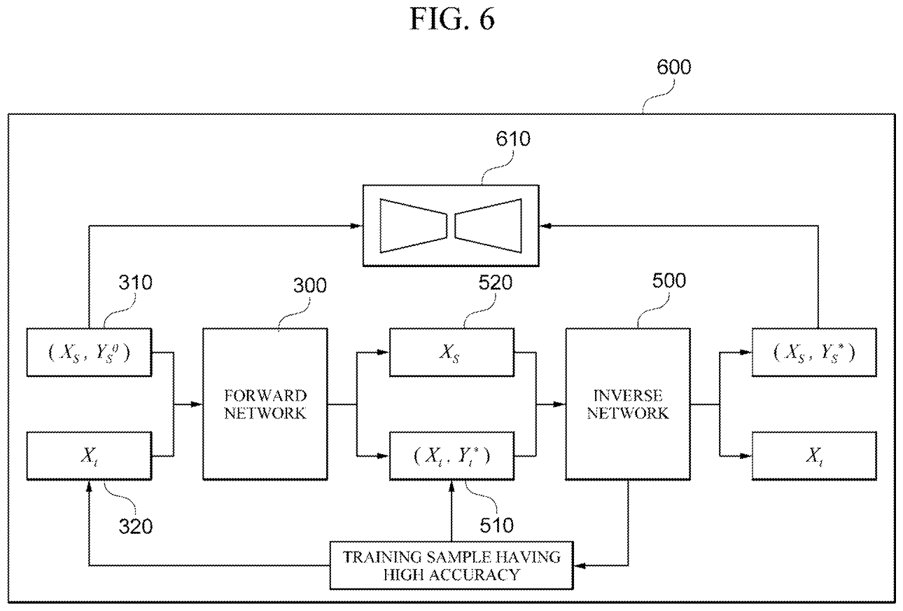

FIG. 6 is a view showing an example of training an integrated network according to an embodiment.

Referring to FIG. 6, the computing device 12 may train the integrated network 600 on the basis of the loss function set in the integrated network 600 so that the value of the second label Yₛ* for the source dataset may approach the value of the first label Yₛ^{o}.

Specifically, the computing device 12 may train so that the loss function set in the integrated network 600 may become minimum. At this point, when the loss function set in the integrated network 600 becomes minimum, the value of the second label Yₛ* for the source dataset may approach the value of the first label Yₛ^{o}.

At this point, the loss function set in the integrated network 600 may be a function generated on the basis of, for example, the loss function set in the forward network 300, the loss function set in the inverse network 500, and the loss function set in a perceptual consistency estimation network 610.

At this point, the perceptual consistency estimation network 610 is for enhancing performance of the forward network 300, the inverse network 500, and the integrated network 600. The loss function set in the perceptual consistency estimation network 610 may be a function generated on the basis of a loss function based on an auto-encoder. At this point, the auto-encoder may mean a neural network designed to make the output data and the input data equal.

Specifically, the perceptual consistency estimation network 610 may be a neural network trained to minimize a result value of the preset loss function on the basis of the source dataset 310 assigned with the first label Yₛ^{o}. At this point, the loss function of the perceptual consistency estimation network 610 may be expressed through mathematical expression 3 shown below.

∥G(Xₛ,Yₛ^{o})−Xₛ∥_{P}, [Mathematical expression 3])

In mathematical expression 3, G denotes the output function of the auto-encoder, Xₛ denotes individual source data included in the source dataset, and Yₛ^{o} denotes the first label.

At this point, G(X, Y) is a function trained to output X when X and Y are inputted.

Finally, the loss function set in the integrated network 600 may be expressed through mathematical expression 4 shown below.

L_{FN}(Xₛ,Yₛ^{o},Xₜ)+L_{IN}(Xₜ,Yₜ*,Xₛ)+λ∥(G(Xₛ,Yₛ*)−Xₛ∥ₚ [Mathematical expression 4]

In mathematical expression 4, L_{FN} denotes the loss function set in the forward network 300, L_{IN} denotes the loss function set in the inverse network 500, Xₜ denotes individual target data included in the target dataset, Yₜ* denotes the third label, Yₛ* denotes the second label, and λ and [symbol] denotes control parameters.

At this point, the computing device 12 may determine that training of the integrated network 600 is successful as the value of the second label Yₛ* approaches the value of the first label Yₛ^{o}.

Next, the computing device 12 may calculate accuracy of each of a plurality of training samples included in the source dataset and the target dataset on the basis of the final noisy label matrix, and train the integrated network 600 using a training sample of which the accuracy is higher than a preset value, among the plurality of training samples. At this point, the accuracy may mean accuracies of the value of the third label extracted through the forward network 399 and the value of the second label extracted through inverse network 500 by comparing with the value of a label, which is the answer of individual data.

Accordingly, the computing device 12 may remove training samples having many errors and enhance stability of training by training the integrated network 600 using a training sample having high accuracy.

Meanwhile, the embodiments of the present invention may include programs for performing the methods described in this specification on a computer and computer-readable recording media including the programs. The computer-readable recording media may store program commands, local data files, local data structures and the like independently or in combination. The media may be specially designed and configured for the present invention or may be commonly used in the field of computer software. Examples of the computer-readable recording media include magnetic media such as a hard disk, a floppy disk and a magnetic tape, optical recording media such as CD-ROM and DVD, and hardware devices specially configured to store and execute program commands, such as ROM, RAM, flash memory and the like. An example of the program may include a high-level language code that can be executed by a computer using an interpreter or the like, as well as a machine code generated by a compiler.

According to the disclosed embodiments, performance of deep learning can be enhanced by performing bidirectional training of learning information on the target dataset on the basis of the source dataset and learning information on the source dataset on the basis of the target dataset.

The technical features have been described above focusing on embodiments. However, the disclosed embodiments should be considered from the descriptive viewpoint, not the restrictive viewpoint, and the scope of the present invention is defined by the claims, not by the descriptions described above, and all the differences within the equivalent scope should be interpreted as being included in the scope of the present invention.

What is claimed is:

1. A method for training deep learning model, which is performed by a computing device comprising one or more processors and a memory for storing one or more programs executed by the one or more processors, the method comprising:
training a deep learning-based forward network using a source dataset assigned with a first label and a target dataset not assigned with a label as training data;
determining a final noisy label matrix for a deep learning-based inverse network using a plurality of previously generated noisy label matrixes and the inverse network;
training the inverse network on the basis of the final noisy label matrix;
training a deep learning-based integrated network, which is combined the trained forward network and the trained inverse network, on the basis of the first label and a second label of the source dataset; and
determining the forward network included in the trained integrated network as a deep learning model.

2. The method according to claim 1, wherein the training of the forward network comprises training the forward network to extract a label for the target dataset not assigned with a label on the basis of the source dataset assigned with the first label, wherein the forward network is trained on the basis of a loss function set in the forward network.

3. The method according to claim 1, further comprising extracting a third label for the target dataset not assigned with a label from the source dataset assigned with the first label and the target dataset not assigned with a label using the trained forward network.

4. The method according to claim 3, wherein the determining of the final noisy label matrix comprises:
training the inverse network for the first time to extract a label for the source dataset not assigned with a label on the basis of the target dataset assigned with the third label, wherein the inverse network is trained on the basis of a loss function set in the inverse network;
retraining the first-time trained inverse network on the basis of each of the plurality of noisy label matrixes;
extracting a fourth label for the source dataset not assigned with a label from the target dataset assigned with the third label and the source dataset not assigned with a label using the trained inverse network on the basis of the each of the plurality of noisy label matrixes; and
determining one of the plurality of noisy label matrixes as the final noisy label matrix on the basis of the first label and the fourth label.

5. The method according to claim 4, wherein the training of the inverse network comprises retraining the first-time trained inverse network on the basis of the final noisy label matrix and a loss function based on cross entropy.

6. The method according to claim 3, wherein the training of the inverse network comprises extracting the second label for the source dataset not assigned with a label from the target dataset assigned with the third label and the source dataset not assigned with a label using the trained inverse network, and the training of the integrated network comprises training the integrated network on the basis of the loss function set in the integrated network so that the value of the second label may approach the value of the first label.

7. The method according to claim 6, wherein the loss function set in the integrated network is generated on the basis of loss functions respectively set in the forward network and the inverse network and a loss function based on an auto-encoder.

8. The method according to claim 1, wherein the training of the integrated network comprises calculating accuracy of each of a plurality of training samples included in the source dataset and the target dataset on the basis of the final noisy label matrix, and training the integrated network using a training sample of which the accuracy is higher than a preset value among the plurality of training samples.

9. An apparatus for training deep learning model comprising one or more processors, a memory, and one or more programs, wherein the one or more programs are stored in the memory and configured to be executed by the one or more processors and comprise instructions for executing the steps of:
training a deep learning-based forward network using a source dataset assigned with a first label and a target dataset not assigned with a label as training data;
determining a final noisy label matrix for a deep learning-based inverse network using a plurality of previously generated noisy label matrixes and the inverse network;
training the inverse network on the basis of the final noisy label matrix;
training a deep learning-based integrated network, which is combined the trained forward network and the trained inverse network, on the basis of the first label and a second label of the source dataset; and
determining the forward network included in the trained integrated network as a deep learning model.

10. The apparatus according to claim 9, wherein the step of training the forward network trains the forward network to extract a label for the target dataset not assigned with a label on the basis of the source dataset assigned with the first label, wherein the forward network is trained on the basis of a loss function set in the forward network.

11. The apparatus according to claim 9, wherein the one or more programs further comprise instructions for executing the step of extracting a third label for the target dataset not assigned with a label from the source dataset assigned with the first label and the target dataset not assigned with a label using the trained forward network.

12. The apparatus according to claim 11, wherein the step of determining a final noisy label matrix includes the steps of:
training the inverse network for the first time to extract a label for the source dataset not assigned with a label on the basis of the target dataset assigned with the third label, wherein the inverse network is trained on the basis of a loss function set in the inverse network;
retraining the first-time trained inverse network on the basis of each of the plurality of noisy label matrixes;
extracting a fourth label for the source dataset not assigned with a label from the target dataset assigned with the third label and the source dataset not assigned with a label using the trained inverse network on the basis of the each of the plurality of noisy label matrixes; and
determining one of the plurality of noisy label matrixes as the final noisy label matrix on the basis of the first label and the fourth label.

13. The apparatus according to claim 12, wherein the step of training the inverse network comprises the step of retraining the first-time trained inverse network on the basis of the final noisy label matrix and a loss function based on cross entropy.

14. The apparatus according to claim 11, wherein the step of training the inverse network extracts the second label for the source dataset not assigned with a label from the target dataset assigned with the third label and the source dataset not assigned with a label using the trained inverse network, and the step of training an integrated network trains the integrated network on the basis of the loss function set in the integrated network so that the value of the second label may approach the value of the first label.

15. The apparatus according to claim 14, wherein the loss function set in the integrated network is generated on the basis of loss functions respectively set in the forward network and the inverse network and a loss function based on an auto-encoder.

16. The apparatus according to claim 9, wherein the step of training the integrated network calculates accuracy of each of a plurality of training samples included in the source dataset and the target dataset on the basis of the final noisy label matrix, and trains the integrated network using a training sample of which the accuracy is higher than a preset value among the plurality of training samples.
